(19) United States
(12) Patent Application Publication
(10) Pub. No.: US 2003/0193032 A1
(43) Pub. Date: Oct. 16, 2003

(54) Radiation exposure indicator device

(75) Inventor: Kenneth J. Marshall, Brockport, NY (US)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 10/118,088

(22) Filed: Apr. 8, 2002

(51) Int. Cl. G01T 1/06

(52) U.S. Cl. 250/474.1

(57) ABSTRACT

A radiation exposure indicator device is described comprising glass which provides a directly visually observable color change upon exposure to radiation, wherein the glass is in the form of glass fibers. A method of detecting exposure of an item to irradiation is also described, comprising attaching a radiation exposure indicator to the item or packaging thereof, the exposure indicator comprising glass which provides a visually observable color change upon exposure to radiation wherein the glass is in the form of glass fibers, and monitoring the exposure indicator for a visual color change. The present invention provides a passive dosimeter which may be affixed to or integrated into various items (e.g., mail, envelopes, stamps, labels, over-packs, packages, shipping containers, etc.) which is inexpensive to manufacture, while providing design flexibility to enable fabrication into a variety of desired shapes and sizes. In preferred embodiments of the invention, the described devices may be used to counter terrorism by providing a means to provide a positive visual color indication of package or mail irradiation from electron beam and radiation-based security systems.

### FIELD OF THE INVENTION

This invention relates to a radiation exposure indicator and in particular to a device having one or more components capable of changing color in response to exposure to radiation.

### BACKGROUND ON THE INVENTION

Radiation emitting technologies such as electrons in an electron beam sanitation systems and/or X-rays from security inspection systems can be used as mechanisms to counter terrorism. Examples of such applications are electron beam and gamma irradiation can be used to sterilize and protect against biological pathogens in transported packages. In addition, X-ray imaging technology permits a scan inside of transported materials to look for bombs, weapons and smuggled materials. While these technologies provide a deterrent for acts of terrorism, there is often no practical mechanism in place to verify whether individual packages have been exposed to these radiation-based technologies. Packages and luggage composed of typical materials (cardboard, paper and ink, plastics, metal) that are subjected to electron beam sterilization or x-ray inspection often do not demonstrate any obvious changes after exposure and it is difficult for a recipient or inspector to determine if a package was indeed exposed to the radiation-based security system. Conversely, there is potential for products that are sensitive to elevated levels of radiation (e.g. photographic films, electronics, seeds etc.) to be damaged unknowingly from radiation-based security systems.

The use of dosimeters to determine a specific absorbed dose of ionizing radiation to persons or host to which it is attached is established. There are many types of dosimeters that can be affixed or mounted on a package, however such known dosimeters for indicating exposure to ionizing radiation systems have various limitations.

Electronic dosimeters are devices with small gas filled detector tubes that contain a pressurized gas that is near the ionization state. When the gas inside the tube reacts with ionizing radiation, electronics coupled to the tube register current and can interpret that signal as an exposure of radiation. Such devices require sophisticated electronics that are subject to being damaged or destroyed from elevated doses of ionizing radiation. In addition electronic devices require external calibration and training to use properly. The expense of the electronic components, calibration and fragility make these devices impractical.

A film dosimeter is a small light-tight paper envelope that houses one or more pieces of undeveloped dental-type photographic film. The envelope is usually fitted within a housing that contains various filters to allow filtration of specific radiation by type and energy. After the film is photographically developed, the degree of fogging (blackening) of the film will correspond to a specific dose of radiation received by the dosimeter. Inherent in the use of such a badge is the need of an external developing process for the film.

Radiation-responsive glasses have been proposed for use in measuring X-rays, beta rays, gamma rays and other high energy radiation by noting color changes produced in such glasses as a result of exposure to such radiation. Several compositions for such glasses are described, e.g., in U.S. Pat. Nos. 2,770,922, 2,782,319, 3,899,679 and 4,494,003. U.S. Pat. No. 4,494,003, in particular, discloses the use of glass doped with iron or manganese in parts per million levels for detecting exposure to gamma ray (electromagnetic) radiation, where color change in the doped glass is measured as a function of gamma radiation. Further described is the use of an instrument providing a fixed calibrated source of light to measures the amount of gamma radiation detected by the glass. That is, one can measure the attenuation of light transmission through the gamma-irradiated sample of glass as a function of gamma exposure. Gamma dosage can also be calculated as a function of the change of the refraction index of the glass. Also the amount of radiation can be determined with an external color chart. There is no disclosure, however, with respect to exposure to particle radiation such as electron exposure from electron beam sanitation systems. Further, the dosimeter examples described specifically for use in gamma ray exposure detection (e.g., described as a single piece of glass hung on a person or area and also worn as a watch crystal) are glass pieces which are not reliably robust for application to the exterior of a shipped package, as they would be fragile and subject to breakage in packaging and shipping environments where the glass may come into repeated contact with other items.

Glasses comprising silver halide crystals selected from the group consisting of AgCl, AgBr, AgI, and mixtures thereof in the glass are known to demonstrating photochromic behavior. Glass compositions which darken under the influence of actinic radiation, commonly ultraviolet radiation, and then return to their original state when the radiation is removed, e.g., were originally described in U.S. Pat. No.3,208,860. As described therein, photochromic glasses were produced in a R₂O—Al₂O₃—B₂O₃—SiO₂ base glass system. The base glass consisted essentially of 4-26% Al₂O₃, 4-26% B₂O₃, 40-76% SiO₂, and R₂O, the R₂O being selected from the group consisting of 2-8% Li₂O,4-15% Na₂O,6-20% K₂O, 8-25% Rb₂O, and 10-30% Cs₂O, the total of these basic ingredients being at least 85%. To provide photochromic properties, the glass contained at least one halide in a minimum amount of 0.2% Cl, 0.1% Br, and 0.08% I, and silver in a minimum amount of 0.2%, 0.05% and 0.03% where the added halide is, respectively, Cl, Br, or I. Subsequent to this disclosure, primary further interest with respect to photochromic glasses has been in obtaining glass compositions that darken rapidly to a moderately low luminous transmittance under the influence of an exciting radiation, and then fade rapidly to the original transmittance when removed from the exciting radiation. Additional representative disclosures pertinent to photochromic glasses include U.S. Pat. Nos. 4,001,019, 4,407,966, and 5,256,601.

U.S. Pat. Nos. 5,811,822 and 6,087,666 disclose optically transparent, optically stimulable glass composites for radiation dosimetry, wherein the glass composites in one embodiment may comprise a glass matrix which includes ZnS doped with copper, lead, manganese, or cerium. Rather than provide a visually observable color change directly in the glass material upon exposure to radiation, the glass matrix material in such system is designed to store energy from ionizing radiation when exposed thereto, and release the energy (i.e., luminesce) when stimulated by exposure to light of a stimulating wavelength. To provide ability to monitor radiation exposure levels at remote locations, the stimulating light and luminescent light may be transported to and from the glass matrix material dosimeter by fiber optics.

U.S. Pat. No. 5,323,011 discloses a fiber optic ionizing radiation detector employing a coiled optical fiber as the medium for sensing ionizing radiation emitted by a radioactive source. Rather than provide a visually observable color change directly in the optical fiber upon exposure to radiation, attenuation of light transmission pumped through the optical fiber is measured as a function of radiation exposure.

It would be desirable to provide a radiation exposure indicator device which would be applicable to monitoring exposure to particle radiation such as electron exposure from electron beam sanitation systems, as well as gamma radiation exposure. Further, it would be desirable to provide such an indicator device which would be robust for application to the exterior of shipped packages, and which did not require external processing or electronic devices for reading thereof.

### SUMMARY OF THE INVENTION

In accordance with one embodiment of the invention, a radiation exposure indicator device is described comprising glass which provides a directly visually observable color change upon exposure to radiation, wherein the glass is in the form of glass fibers.

In accordance with a second embodiment of the invention, a method of detecting exposure of an item to irradiation is described, comprising attaching a radiation exposure indicator to the item or packaging thereof, the exposure indicator comprising glass which provides a visually observable color change upon exposure to radiation wherein the glass is in the form of glass fibers, and monitoring the exposure indicator for a visual color change.

The present invention improves on the heretofore known dosimeters by providing a passive dosimeter which may be affixed to or integrated into various items (e.g., mail, envelopes, stamps, labels, over-packs, packages, shipping containers, etc.) which is inexpensive to manufacture, while providing design flexibility to enable fabrication into a variety of desired shapes and sizes. The present invention is also advantageous in that it does not require external processing, electronic devices, or other materials to read or use. In preferred embodiments of the invention, the described devices may be used to counter terrorism by providing a means to provide a positive visual color indication of package or mail irradiation from electron beam and radiation-based security systems.

### DETAILED DESCRIPTION OF THE INVENTION

The invention is directed towards the use of radiation sensitive glass compositions which provide a directly visually observable color change upon exposure to radiation, which glass compositions have been spun or similarly otherwise formed into glass fibers (glass wool). Various radiation sensitive glass compositions are known in the art which may be used in accordance with the present invention, such as those described in U.S. Pat. Nos. 2,770,922, 2,782,319, 3,899,679 and 4,494,003, as well as in 3,208,860, 4,001,019, 4,407,966, and 5,256,601, the disclosures of which are incorporated by reference herein. For the purposes of the invention, a “color change” is intended to cover visually observable changes in color densities as well as changes in color hues.

In accordance with a particular embodiment of the invention, the radiation sensitive glass composition may comprise a manganese doped glass, such as described, e.g., in U.S. Pat. No. 4,494,003 referenced above. Upon exposure to radiation, such doped glass exhibits a directly observable color change from colorless (clear) to purple (dark) as the result of Mn⁺² being oxidized by radiation events to Mn⁺³. Manganese concentrations of from about 1×10⁻⁹ to about 25 wt percent (i.e., in the parts per billion to parts per hundred range) will generally be effective for providing some level of color change for some level of radiation, and the actual color change upon exposure to radiation will be dependent on the concentration of manganese, the energy of the incoming radiation and the absorbed dose of the dosimeter. The broad range of manganese concentration applicable to glass fiber dosimeters of the invention enables the sensitivity to be adjusted for a greater variety of applications, and the concentration of manganese can be adjusted to indicate a specific threshold to provide a “yes/no” visual color change for a specific electron beam/ionizing radiation source and dose. Glass fibers doped with manganese at a concentration of from about 1×10⁻⁹ to 1×10⁻³ wt percent, for example may be particularly useful for monitoring exposure to electron beam systems, while concentrations of from about 0.5 to 25 wt percent may be particularly useful for monitoring exposure to X-ray Security Inspection systems.

In accordance with a second particular embodiment of the invention, the radiation sensitive glass composition may comprise glass doped with parts per billion (ppb) through parts per hundred (pph) concentrations of silver halide, such as silver chloride, silver bromide, silver iodide, or mixtures thereof, such as described in the various photochromic glass patent references cited above, including, e.g., U.S. Pat. No. 3,208,860. A glass dosimeter containing silver chloride, e.g., will change from clear (colorless) to dark (blacken) when exposed to radiation from radiation-based security systems, as silver halide compositions are sensitive to various forms of radiation. The change of color in response to radiation in silver halide doped glass can be explained as chemical oxidation-reduction reactions. Glass comprising silicates are often transparent to visible light. Where silver halide (AgX) crystals are added during the manufacturing of the glass while it is in the molten state, the crystals become uniformly embedded in the glass as it solidifies. In a manner similar to how silver halide is developed into an image in photographic film, silver halide in the glass undergoes oxidation and reduction by interaction with photons/light as described below.

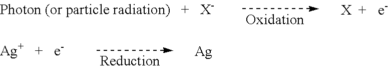

The halide ions are oxidized to produce halogen atoms and an electron. The electron is then transferred to silver ions to produce silver atoms. These atoms cluster together and block the transmittance of light, causing the glass to darken. The degree of “darkening”, or color change, is dependent on the concentration of silver halide, the energy of the incoming radiation and the absorbed dose of the dosimeter. As a rule, the shorter the wavelength of the radiation the glass is exposed to, the greater the degree of darkening, and ionizing radiation like gamma/x-rays will darken more rapidly than exposure from visible light. Therefore, similarly as with manganese doped glass compositions, the concentration of silver halide can be adjusted to indicate a specific threshold to provide a (yes/no) visual color change for a specific radiation source and dose, such as to indicate exposure only to sources of ionizing radiation.

Glass fibers (also commonly known as glass wool) can be made using a variety of conventional techniques. Typically, molten glass is fed from a furnace or “tank” through a channel to a series of bushings which contain accurately dimensioned holes or “forming tips” in its base. A constant head of glass is maintained in the tank and channel and the temperature of the glass in the bushings is controlled to very fine limits. Fine filaments of glass are drawn mechanically downwards from the bushing tips at a speed of several thousand meters per minute, giving a filament diameter which is typically less than 1 mm, and which may be as small as several microns. From the bushing the filaments run to a common collecting point where size is applied and they are subsequently brought together as bundles, or “strands”, on a high speed winder. While the above is given as a general description of a conventional glass fiber making process, the actual process employed is not critical, so long as the glass composition itself is capable of changing color in the presence of radiation.

In accordance with a particular embodiment of the invention, the described dosimeter may be used to determine quantitative or qualitative radiation exposure of packages, baggage and other transported materials that are screened with radiation emitting technologies for security and anti-terrorism purposes. Use of glass in fiber or glass wool form enables relatively flexible devices to be fabricated in a variety of shapes and sizes which may be designed for particular packaging applications, while avoiding the fragile nature of large glass pieces. The radiation sensitive glass wool can be positioned on, in or integrated directly within labels, stamps, packages, envelopes and associated materials prior to shipment. When the package is exposed to an electron beam for sanitation or similar radiation-related processing, the glass changes color verifying exposure. The color change on the package indicates to the recipient that the package has been exposed to the electron beam process appropriately. Conversely, the same dosimeter can be applied to an item or packaging thereof to indicate whether or not radiation sensitive materials (electronics, film, seeds, etc.) have been damaged in shipment unknowingly to the recipient. This indicator cannot eliminate the detrimental effects to such products, however it does provide the recipient with the information that the received goods have been exposed to radiation in transit, preventing the use of the potentially damaged goods and minimizing any further expense of resources with the item.

Radiation sensitive glass fibers may be incorporated into a distinct device employing a support and a layer of the glass fiber which may then be applied to a item to be monitored for exposure or its packaging, or the glass fibers may be applied directly to or incorporated directly into the item itself or its packaging materials. While it is an advantage of the invention that the color change itself may be relied upon as an indication of radiation exposure, the glass fibers may be used in a multi-ply format in combination with written indicia which becomes visible or obscured if desired, such as disclosed in, e.g., U.S. Pat. No. 5,051,597, the disclosure of which is incorporated by reference herein.

Glass fibers used in a radiation exposure indicator device in accordance with the invention can be suspended, dissolved or dispersed into a polymeric resin to enhance its applicability. The resin may serve several purposes. First, the glass fiber and resin mixture can be easily shaped into a desired configuration. Second, glass compositions employed may be sensitive to UV light as well as higher energy radiation sources, especially where the concentration of manganese in the glass composition is higher than 0.05 wt %. While such sensitivity may be used to design a UV radiation exposure indicating device, where the intent is to monitor exposure to higher energy radiation, exposure to UV or sunlight may give a false positive reading on the dosimeter. Accordingly, a polymeric resin may be employed which is selected to substantially block the glass fibers from exposure to ultraviolet light (such as a polycarbonate resin), while permitting higher energy radiation (e.g., gamma, x-rays and/or electron beam) for which exposure is desired to be monitored to interact with the imbedded glass. In addition, the use of a polymeric resin binder for the glass fiber may help provide a more flexible and therefore even further robust dosimeter, as glass fiber imbedded in polymeric resin is less likely to break from physical damage associated with packages in transit. Even if the glass fibers were to break, the pieces would still be retained in the polymer resin and still provide a visual indication of radiation exposure. In an alternative embodiment, radiation sensitive glass fibers employed in accordance with the invention may be over-coated with a polymeric resin to provide similar advantages.

The invention has been described in detail with particular reference to certain preferred embodiments thereof, but it will be understood that variations and modifications can be effected within the spirit and scope of the invention.

What is claimed is:

1. A radiation exposure indicator device comprising glass which provides a visually observable color change upon exposure to radiation, wherein the glass is in the form of glass fibers.

2. An indicator according to claim 1, wherein the glass fibers are doped with manganese at a concentration of from 1×10⁻⁹ to 25 wt percent.

3. An indicator according to claim 2, wherein the glass fibers are doped with manganese at a concentration of from 1×10⁻⁹ to 1×10⁻³ wt percent.

4. An indicator according to claim 2, wherein the glass fibers are doped with manganese at a concentration of from 0.5 to 25 wt percent.

5. An indicator according to claim 1, wherein the glass fibers contain silver halide crystals.

6. An indicator according to claim 1, wherein the glass fibers are imbedded in a polymeric resin.

7. An indicator according to claim 6, wherein the polymeric resin substantially blocks the glass fibers from exposure to ultraviolet light, and permits exposure to higher energy radiation.

8. An indicator according to claim 1, wherein the glass fibers are overcoated with a polymeric resin.

9. An indicator according to claim 8, wherein the polymeric resin substantially blocks the glass fibers from exposure to ultraviolet light, and permits exposure to higher energy radiation.

10. A method of detecting exposure of an item to irradiation, comprising attaching a radiation exposure indicator to the item or packaging thereof, the exposure indicator comprising glass which provides a visually observable color change upon exposure to radiation wherein the glass is in the form of glass fibers, and monitoring the exposure indicator for a visual color change.

11. A method according to claim 10, wherein the glass fibers are doped with manganese at a concentration of from 1×10⁻⁹ to 25 wt percent.

12. A process according to claim 11, wherein the glass fibers are doped with manganese at a concentration of from 1×10⁻⁹ to 1×10⁻³ wt percent.

13. A process according to claim 11, wherein the glass fibers are doped with manganese at a concentration of from 0.5 to 25 wt percent.

14. A process according to claim 10, wherein the glass fibers contain silver halide crystals.

15. A process according to claim 10, wherein the glass fibers are imbedded in a polymeric resin.

16. A process according to claim 15, wherein the polymeric resin substantially blocks the glass fibers from exposure to ultraviolet light, and permits exposure to higher energy radiation.

17. A process according to claim 10, wherein the glass fibers are overcoated with a polymeric resin.

18. A process according to claim 17, wherein the polymeric resin substantially blocks the glass fibers from exposure to ultraviolet light, and permits exposure to higher energy radiation.
